(19) United States
(12) Patent Application Publication
(10) Pub. No.: US 2005/0279221 A1
(43) Pub. Date: Dec. 22, 2005

(54) Apparatus and method for properly pre-measuring turkey frying oil

(76) Inventor: Edward Lee Jantz, Jensen Beach, FL (US)

Correspondence Address: EDWARD LEE JANTZ, 748 NE MARANTA TERRADO, JENSEN BEACH, FL, 34957, US

(21) Appl. No.: 11/151,981

(22) Filed: Jun. 14, 2005

Related U.S. Application Data
(60) Provisional application No. 60/579,645, filed on Jun. 16, 2004.

(51) Int. Cl. A23L 1/00

(52) U.S. Cl. 99/342

(57) ABSTRACT

A way to safely fry turkeys by minimizing the hazard of overfilling oil, the Turkey Oil Gage comprises a device and method to properly pre-measure the frying oil used to fry whole turkeys. It is appropriately sized for a given application measure or object shaped similar to that of a long inverted letter “j”. The Turkey Frying Oil Gage is one part only. The front of the TFOG is embossed or indelibly marked in one pound increments from eleven pounds to twenty-five pounds. This side is also separated into five columns designating pot sizes (quarts) of 26, 28, 30, 32 and 34 quarts. The gage hung from the pot top rim and oil is filled to the turkey weight for the pot size that is used. The oil gage is removed, the oil heated and the turkey introduced without overflowing the oil onto the heating flames.

### RELATED APPLICATIONS

The present application is non-provisional application of U.S. provisional patent application, Application Ser. No. 60/579,645, filed Jun. 16, 2004, for TURKEY OIL GAGE, by Edward Lee Jantz, included by reference herein and for which benefit of the priority date is hereby claimed.

### FIELD OF THE INVENTION

The present invention relates to frying turkeys and, more particularly, to the measurement of the frying medium with respect to the turkey frying vessel and the weight of the turkey being placed in the frying medium.

### BACKGROUND OF THE INVENTION

The last 10 years has seen an explosion of frying turkeys in ones backyard. Fried turkeys cook quickly, yield an exceptionally crispy skin and remain juicy. Upon first frying a turkey, many say they will never cook a turkey any other way. The most common way to fry turkeys is outdoors, in a turkey frying pot. This pot is sold in various sizes and is taller than other commercial pots to facilitate the turkeys oblong shape. The most common size pots are 26, 28, 30, 32 and 34 quart capacities. The oil is most commonly heated in the pot over a gas flame until the oil reaches a temperature of 350 degrees. Upon reaching this temperature the turkey is immersed in the hot oil, usually using a carrier of one kind or other so ones hands would not contact the hot oil. The turkey is then cooked for 3-4 minutes per pound, removed from the oil, drained and consumed.

The process of frying can be dangerous due to the presence of flames and a flammable liquid. As stated, the typical process involves an open flame gas burner, heating a pot which contains oil, to a certain temperature and introducing the prepared turkey into the hot oil for an amount of time. The correct method of deciding how much oil to place in the pot is to place the turkey in the pot, cover with water, remove the turkey, record the level of the water and discard the water. Oil should then be placed to the recorded water level and heated. When this method is not performed the results can be hazardous. Of particular hazard is placing too much oil in the pot, and, as the turkey is immersed in the oil the pot will overflow onto the burner causing a flash fire. This hazard has caused much concern about the safety of frying turkeys due to initial overfilling of the frying oil. It is understood that some manufacturers may remove their turkey frying kits from the market. The Turkey Frying Oil Gage (TFOG) was developed to minimize this hazard when frying by indicating a specific level to fill the oil for a particular size pot based on the weight of the turkey and to eliminate the need for the turkey/water displacement marking method.

No known measuring device has been developed that can be placed in any common size turkey frying pots that will indicate the level of oil to be placed in the pot.

Some newer pots contain embossed weight ranges of turkeys, but no known devices fit multiple vessels and indicate turkey weights to the nearest pound increment.

It is therefore an object of the invention to indicate a level of oil to be placed in a given size turkey frying pot to the correct level required for a particular size turkey.

It is another object of the invention to safely fry turkeys.

It is another object of the invention to reduce the likelihood of overfilling a turkey frying pot causing an unexpected fire

It is another object of the invention to quickly fill a turkey oil frying pot without performing water displacement and marking the water level to indicate oil level.

It is another object of the invention to eliminate the guess work from placing frying oil in a turkey frying pot prior to frying a turkey.

### SUMMARY OF THE INVENTION

In accordance with the present invention, there is provided a way to safely fry turkeys by minimizing the hazard of overfilling oil.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an elevation view.

For purposes of clarity and brevity, like elements and components will bear the same designations and numbering throughout the Figures.

### DESCRIPTION OF THE PREFERRED EMBODIMENT

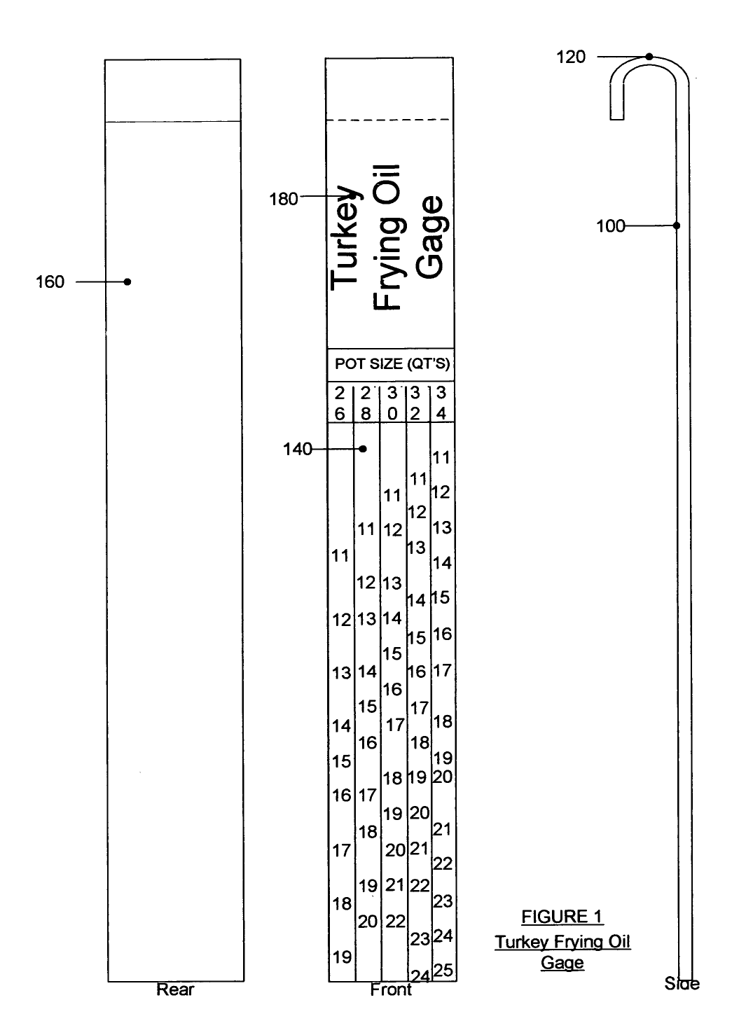

FIG. 1 is the elevation view of the front, back and side of the Turkey Frying Oil Gage. The Turkey Oil Frying Gage 180 is placed in a turkey frying pot and frying oil is placed the level indicated for the weight of the turkey being cooked for the size pot being used. The Turkey Oil Frying Gage 180 may be made of wood, steel, aluminum, plastic or any other suitable material. As an alternative embodiment this gage may recalculated to be placed on the bottom of turkey frying pots.

The main body 100 of Turkey Oil Frying Gage 180 contains General Instructions 160 and a measurement scale 140 to measure the correct level to fill the frying pot. This main body 100 may be made of any material suitable for immersion in cooking oil in which uncooked poultry will be placed. The text, including numerals and symbols may be printed, etched, embossed, raised or indicated by any other means which is suitable for immersion in cooking oil in which uncooked poultry will be placed. The main body 100 must be rigid when placed in the pot containing cooking oil.

The Hanging Element 120 is on the top of the gage and facilitates holding the gage from the top of the frying pot. The Hanging Element 120 may be square, round or any other shape that will allow the gage to be affixed to the top rim of the pot. The Hanging Element 120 may fit loosely or tightly and may attach or be attachable to the scale 140 or main body 100.

The scale 140 of the Turkey Oil Frying Gage 180 indicates the level to which cooking oil will be placed. The scale 140 is headed with five(5) columns for five(5)turkey oil pot sizes or capacities. The turkey frying pot sizes are 26, 28, 30, 32 and 34 quart capacities. Under each column are numbers representing a range of sizes in pounds. The text, including numerals and symbols may be printed, etched, embossed, raised or indicated by any other means which is suitable for immersion in cooking oil in which uncooked poultry will be placed.

General Instructions 160 are placed on the side opposite the scale 140. The text, including numerals and symbols may be printed, etched, embossed, raised or indicated by any other means which is suitable for immersion in cooking oil in which uncooked poultry will be placed. The General Instructions 160 will contain, but not necessarily be limited to use, cautions, safety information, cleaning instructions and any other information pertaining to the proper use of the Turkey Oil Frying Gage 180.

Thus, in summary, the Turkey Oil Frying Gage 180 is hung from the top rim of a turkey frying pot and frying oil is placed the level indicated for the weight of the turkey being cooked for the size pot being used and removed. The oil is heated by various means, of which a gas burner is most common. When the oil reaches optimum cooking temperature, the turkey is slowly introduced into the hot oil to submersion. Using the Turkey Oil Frying Gage 180 will assure that when the gage is correctly used to fill the pot with oil, that the oil will not overflow onto the cooking flames causing a hazardous condition and unnecessarily wasting of cooking oil.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention:

Having thus described the invention, what is desired to be protected by Letters Patent is presented in the subsequently appended claims.

1. An apparatus for properly pre-measuring turkey frying oil into various frying pots for frying turkeys comprising:
means for the measurement of oil to safely fry a turkey;
means to carry information for essential use of the gage;
means for the function of this element is to support the gage; and
means is to provide a height to fill the pot with oil, rigidly connected to said means for the function of this element is to support the gage.

2. The turkey frying oil gage in accordance with claim 1, wherein said means for the measurement of oil to safely fry a turkey comprises a turkey oil frying gage.

3. The turkey frying oil gage in accordance with claim 1, wherein said means for to carry information for essential use of the gage comprises the gage body main body.

4. The turkey frying oil gage in accordance with claim 1, wherein said means for the function of this element is to support the gage comprises a rim hanging element.

5. The turkey frying oil gage in accordance with claim 1, wherein said means for is to provide a height to fill the pot with oil comprises a scale.

6. A turkey frying oil gage for measuring of frying oil into various frying pots for frying turkeys from the use of a oil level measuring tool for a specific size frying pot and a specific size turkey, comprising:
a turkey oil frying gage, for the measurement of oil to safely fry a turkey;
the gage body main body, to carry information for essential use of the gage;
a rim hanging element, for the function of this element is to support the gage; and
a scale, for is to provide a height to fill the pot with oil, rigidly connected to said Hanging Element.

7. A turkey frying oil gage for measuring of frying oil into various frying pots for frying turkeys from the use of a oil level measuring tool for a specific size frying pot and a specific size turkey, comprising:
a turkey oil frying gage, for the measurement of oil to safely fry a turkey;
the gage body main body, to carry information for essential use of the gage;
a rim hanging element, for the function of this element is to support the gage; and
a scale, for is to provide a height to fill the pot with oil, rigidly connected to said Hanging Element.

8. A method for properly pre-measuring turkey frying oil into various frying pots for frying turkeys comprising:
means for the measurement of oil to safely fry a turkey;
means to carry information for essential use of the gage;
means for the function of this element is to support the gage; and
means is to provide a height to fill the pot with oil, rigidly connected to said means for the function of this element is to support the gage.

9. The turkey frying oil gage in accordance with claim 8, wherein said means for the measurement of oil to safely fry a turkey comprises a turkey oil frying gage.

10. The turkey frying oil gage in accordance with claim 8, wherein said means for to carry information for essential use of the gage comprises the gage body main body.

11. The turkey frying oil gage in accordance with claim 8, wherein said means for the function of this element is to support the gage comprises a rim hanging element.

12. The turkey frying oil gage in accordance with claim 8, wherein said means for is to provide a height to fill the pot with oil comprises a scale.
